(19) United States
(12) Patent Application Publication
(10) Pub. No.: US 2010/0227938 A1
(43) Pub. Date: Sep. 9, 2010

(54) METHOD FOR THE PRODUCTION OF OPEN-CELL VISCOELASTIC SOFT POLYURETHANE FOAMS

(75) Inventors: Stephan Bauer, Ostercappeln (DE); Stefan Meyer, Cloppenburg (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/161,343

(22) PCT Filed: Jan. 16, 2007
(86) PCT No.: PCT/EP07/50367

§ 371 Date: Jul. 18, 2008

(30) Foreign Application Priority Data
Jan. 27, 2006 (EP) 06100959.3

(51) Int. Cl. C08J 9/00; C08G 18/28

(52) U.S. Cl. 521/170

(57) ABSTRACT

The invention relates to a process for producing open-celled viscoelastic flexible polyurethane foams based on renewable raw materials by reacting
a) polyisocyanates with
b) a polyol mixture comprising
bi) compounds having at least two hydrogen atoms which are reactive toward isocyanate groups and an OH number of from 20 to 100 mg KOH/g and
bii) compounds having at least two hydrogen atoms which are reactive toward isocyanate groups and an OH number of from 100 to 800 mg KOH/g and
biii) compounds having at least one and not more than two hydrogen atoms which are reactive toward isocyanate groups and an OHN of from 100 to 800 mg KOH/g,
c) and blowing agents,
   wherein the components bi) and bii) each comprise at least one compound which comprises renewable raw materials or reaction products thereof.

The invention relates to a process for producing viscoelastic flexible polyurethane foams using polyether alcohols based on renewable raw materials, in particular castor oil.

Flexible polyurethane foams are used in many industrial fields, in particular for upholstery or sound damping. They are usually produced by reacting polyisocyanates with compounds having at least two hydrogen atoms which are reactive toward isocyanate groups in the presence of blowing agents and also, if appropriate, catalysts and customary auxiliaries and/or additives.

For ecological reasons, the market is increasingly demanding foams which comprise renewable raw materials. In the production of polyurethanes, renewable raw materials could also be seen as an alternative to starting materials of petrochemical origin. The foams are usually produced using hydroxyl-comprising natural materials or polyols which are prepared by addition of alkylene oxides onto these compounds.

Examples of compounds from renewable raw materials are castor oil, polyhydroxy fatty acid, ricinoleic acid, hydroxyl-modified oils such as grapeseed oil, black cumin oil, pumpkin seed oil, borage seed oil, soybean oil, wheatgerm oil, rapeseed oil, sunflower oil, peanut oil, apricot kernel oil, pistachio oil, almond oil, olive oil, macadamia nut oil, avocado oil, sea buckthorn oil, sesame oil, hemp oil, hazelnut oil, evening primrose oil, wild rose oil, hemp oil, safflower oil, walnut oil, hydroxyl-modified fatty acids and fatty acid esters based on myristoleic acid, palmitoleic acid, oleic acid, vaccenic acid, petroselinic acid, gadoleic acid, erucic acid, nervonic acid, linoleic acid, α- and γ-linolenic acid, stearidonic acid, arachidonic acid, timnodonic acid, clupanodonic acid, cervonic acid. Among these, castor oil and hydrogenated castor oil have the greatest industrial importance.

The reaction of compounds from renewable raw materials with the alkylene oxides can here be carried out in a customary and known manner.

WO 00/44813 discloses the preparation of polyether alcohols by alkoxylation of castor oil using multimetal cyanide compounds, frequently also referred to as DMC catalysts.

WO 04/20497 discloses the use of polyether alcohols which have been prepared by addition of alkylene oxides onto natural products, in particular castor oil, for producing flexible polyurethane foams having reduced fogging. Such foams are used, in particular, for the interior trim of motor vehicles.

A particular class of materials within flexible polyurethane foams is the viscoelastic foams.

For the purposes of the present invention, a foam is referred to as viscoelastic if it has a loss factor in the torsional vibration test in accordance with DIN 53445 of greater than 0.15, preferably greater than 0.2. Furthermore, it is preferred that the foams of the invention display viscoelastic behaviour over a wide temperature range, i.e. from −20° C. to +50° C., but at least from 0 to +40° C.

The foam can likewise be referred to as viscoelastic if it has a rebound resilience measured in accordance with DIN EN ISO 8307 of less than 30%, preferably from 2 to 25%, particularly preferably from 3 to 20%.

In particular, it is preferred that the foam of the invention meets both the abovementioned criteria for the loss factor and for the rebound resilience.

The viscoelastic foams of the invention having the above-described damping coefficients are “slow” foams.

Such foams are used, in particular, for sound damping and for producing mattresses or cushions. In these applications, it is also important that the foams have a good aging resistance, in particular when stored under hot and humid conditions. Furthermore, the redissociation of the urethane bonds, which can lead to the formation of aromatic amines, should be substantially suppressed.

It is accordingly an object of the present invention to provide viscoelastic flexible polyurethane foams which are produced on the basis of renewable raw materials and have good mechanical properties, low odor and low emissions and display good long-term stability, in particular when stored under hot and humid conditions.

The object has surprisingly been able to be achieved by using at least two polyols based on renewable raw materials and having different hydroxyl numbers in the production of the flexible polyurethane foams.

The present invention accordingly provides a process for producing viscoelastic flexible polyurethane foams based on renewable raw materials by reacting
a) polyisocyanates with
b) compounds having hydrogen atoms which are reactive toward isocyanate groups, comprising
bi) compounds having at least two hydrogen atoms which are reactive toward isocyanate groups and an OH number of from 20 to 100 mg KOH/g and
bii) compounds having at least two hydrogen atoms which are reactive toward isocyanate groups and an OH number of from 100 to 800 mg KOH/g and
biii) compounds having at least one and not more than two hydrogen atoms which are reactive toward isocyanate groups and an OHN of from 100 to 800 mg KOH/g, and
c) blowing agents,
   wherein the components bi) and bii) each comprise at least one compound which comprises renewable raw materials or reaction products thereof.

The invention further provides the viscoelastic flexible polyurethane foams produced by this process.

In addition, the invention provides for the use of the open-celled viscoelastic flexible polyurethane foams of the invention for producing furniture and mattresses and in automobile interiors, in particular for the backfoaming of automobile carpets.

The proportion of renewable raw materials in the foam is preferably at least 20% by weight, particularly preferably above 30% by weight and in particular above 40% by weight.

The components bi) and bii) can also consist exclusively of compounds derived from renewable raw materials.

The component b) preferably comprises 5-45% by weight, in particular 10-25% by weight, of bi), 30-90% by weight, in particular 50-80% by weight, of bii) and 5-40% by weight, in particular 10-30% by weight, of biii), with the percentages being based on the sum of bi), bii) and biii).

As compounds derived from renewable raw materials, use is made of, in particular, the above-described renewable or modified renewable raw materials such as oils, fatty acids and fatty acid esters which have a mean OH functionality of at least from 2 to 16, preferably from 2 to 8 and very preferably from 2 to 4.

The compounds derived from renewable raw materials are preferably selected from the group consisting of castor oil, polyhydroxy fatty acid, ricinoleic acid, hydroxyl-modified oils such as grapeseed oil, black cumin oil, pumpkin seed oil, borage seed oil, soybean oil, wheatgerm oil, rapeseed oil, sunflower oil, peanut oil, apricot kernel oil, pistachio oil, almond oil, olive oil, macadamia nut oil, avocado oil, sea buckthorn oil, sesame oil, hemp oil, hazelnut oil, evening primrose oil, wild rose oil, hemp oil, safflower oil, walnut oil and also hydroxyl-modified fatty acids and fatty acid esters based on myristoleic acid, palmitoleic acid, oleic acid, vaccenic acid, petroselinic acid, gadoleic acid, erucic acid, nervonic acid, linoleic acid, α- and γ-linolenic acid, stearidonic acid, arachidonic acid, timnodonic acid, clupanodonic acid, cervonic acid.

Commercial products of compounds modified chemically with hydroxyl groups are, for example, Merginat® PV 204, 206 and 235, and the polyhydroxy fatty acid PHF 110 from Harburger Fettchemie.

Castor oil and/or hydrogenated castor oil are/is preferably used as compound derived from renewable raw materials.

The reaction of the compounds derived from renewable raw materials with the alkylene oxides can be carried out in a customary and known manner. It is usual to mix the starting compound with a catalyst and to react this mixture with alkylene oxides. The addition reaction of the alkylene oxides is usually carried out under the customary conditions at temperatures in the range from 60 to 180° C., preferably from 90 to 140° C., in particular from 100 to 130° C., and pressures in the range from 0 to 20 bar, preferably in the range from 0 to 10 bar and in particular in the range from 0 to 5 bar. As alkylene oxides, preference is given to using ethylene oxide, propylene oxide or any mixtures of these compounds.

As catalysts, preference is given to using basic compounds, with potassium hydroxide having the greatest industrial importance. In addition, multimetal cyanide compounds, frequently also referred to as DMC catalysts, are also used as catalyst, as described, for example, in EP 654 302, EP 862 947, WO 99/16775, WO 00/74845, WO 00/74843 and WO 00/74844.

As alkylene oxides, it is possible to use all known alkylene oxides, for example ethylene oxide, propylene oxide, butylene oxide, styrene oxide. In particular, ethylene oxide, propylene oxide and mixtures of the compounds mentioned are used as alkylene oxides.

It is known from DE 10240186 that multimetal cyanide compounds, frequently also referred to as DMC catalysts, are particularly suitable for the alkoxylation of renewable raw materials such as castor oil. These polyols prepared in this way preferably have a content of cyclic fatty acid esters of not more than 10 ppm and therefore have very low emissions.

The compounds bi) preferably have a hydroxyl number of from 20 to 100 mg KOH/g at a viscosity in the range from 400 to 6000 mPa·s. Preference is given to using polyetherols based on castor oil and having a hydroxyl number of from 30 to 80 mg KOH/g, preferably from 45 to 60 mg KOH/g. These preferably have a content of primary hydroxyl groups of less than 10% by weight, preferably less than 5% by weight, based on the weight of the polyether alcohol. In particular, the addition reaction of the alkylene oxides is carried out by means of DMC catalysis.

The compounds bii) preferably have a hydroxyl number of from 100 to 800 mg KOH/g. As compounds derived from renewable raw materials, use is made, in particular, of the above-described renewable or modified renewable raw materials such as oils, fatty acids and fatty acid esters. If appropriate, these can be reacted with the alkylene oxides such as ethylene oxide, propylene oxide or any mixtures of these compounds using suitable catalysts. Very particular preference is given to using castor oil as compound bii).

The components bi) and bii) may, if appropriate, comprise not only the compounds derived from renewable raw materials but also further polyols, in particular polyether alcohols which are prepared by known methods, usually by catalytic addition of alkylene oxides, in particular ethylene oxide and/or propylene oxide, onto H-functional starter substances or by condensation of tetrahydrofuran. As H-functional starter substances, use is made of, in particular, polyfunctional alcohols and/or amines. Preference is given to using water, dihydric alcohols, for example ethylene glycol, propylene glycol or butanediols, trihydric alcohols, for example glycerol or trimethylolpropane, and also higher-functional alcohols such as pentaerythritol, sugar alcohols, for example sucrose, glucose or sorbitol. Preferred amines are aliphatic amines having up to 10 carbon atoms, for example ethylenediamine, diethylenetriamine, propylenediamine, and also amino alcohols such as ethanolamine or diethanolamine. As alkylene oxides, preference is given to using ethylene oxide and/or propylene oxide, with an ethylene oxide block frequently being added on at the end of the chain in the case of polyether alcohols which are used for the production of flexible polyurethane foams. As catalysts in the addition reaction of the alkylene oxides, use is made of, in particular, basic compounds, with potassium hydroxide having achieved the greatest industrial importance here. If the content of unsaturated constituents in the polyether alcohols is to be low, DMC catalysts can also be used as catalysts for preparing these polyether alcohols.

For particular applications, in particular to increase the hardness of the flexible polyurethane foams, it is also possible to make concomitant use of polymer-modified polyols. Such polyols can be prepared by, for example, in situ polymerization of ethylenically unsaturated monomers, preferably styrene and/or acrylonitrile, in polyether alcohols. Polymer-modified polyether alcohols also include polyether alcohols comprising polyurea dispersions, which are preferably prepared by reaction of amines with isocyanates in polyols.

Suitable compounds biii) are monools and diols having a hydroxyl number of from 100 to 800 mg KOH/g. Particular preference is given to polyalkylene glycols, benzyl alcohol, C4-C18-monoalcohols, C8-C18-oxo alcohol ethoxylates, e.g. the Lutensol® A.N, AO, AP, AT, F, ON, TO, XL, XP, AP grades from BASF AG. Very particular preference is given to using polypropylene oxides such as Lupranol 1000, 1100 and 1200, and monools such as Lutensol® A4N, AO3 ON 30, ON 40, TO2, TO3, XA 30, XA 40, XP 30, XP 40, XL 40 and benzyl alcohol.

The preparation of the viscoelastic flexible polyurethane foams of the invention can be carried out by customary and known methods.

With regard to the starting compounds used for the process of the invention, the following details may be provided:

As polyisocyanates a), it is possible to use all isocyanates having two or more isocyanate groups in the molecule in the process of the invention. Use can here be made of either aliphatic isocyanates such as hexamethylene diisocyanate (HDI) or isophorone diisocyanate (IPDI) or preferably aromatic isocyanates such as tolylene diisocyanate (TDI), diphenylmethane diisocyanate (MDI) or mixtures of diphenylmethane diisocyanate and polymethylenepolyphenylene polyisocyanates (crude MDI), preferably TDI and MDI, particularly preferably TDI. Very particular preference is given to a mixture of 80% by weight of tolylene 2,4-diisocyanate and 20% by weight of tolylene 2,6-diisocyanate. It is also possible to use isocyanates which have been modified by incorporation of urethane, uretdione, isocyanurate, allophanate, uretonimine and other groups, known as modified isocyanates. Preferred prepolymers are MDI prepolymers having an NCO content of from 20 to 35% or their mixtures with polymethylenepolyphenylene polyisocyanates (crude MDI).

The polyether alcohols bi), bii) and biii) used according to the invention can be used either alone or in combination with other compounds having at least two hydrogen atoms which are reactive toward isocyanate groups.

Possible compounds having at least two active hydrogen atoms b) which can be used together with the polyether alcohols bi), bii) and biii) used according to the invention are, in particular, polyester alcohols and preferably polyether alcohols having a functionality of from 2 to 16, in particular from 2 to 8, preferably from 2 to 4, and a mean molecular weight Mw in the range from 400 to 20 000 g/mol, preferably from 1000 to 8000 g/mol.

The compounds having at least two active hydrogen atoms b) also include chain extenders and crosslinkers. As chain extenders and crosslinkers, preference is given to using 2- and 3-functional alcohols having molecular weights of from 62 to 800 g/mol, in particular in the range from 60 to 200 g/mol. Examples are ethylene glycol, propylene glycol, diethylene glycol, triethylene glycol, dipropylene glycol, tripropylene glycol, low molecular weight polypropylene oxides and polyethylene oxides, e.g. Lupranol® 1200, 1,4-butanediol, glycerol and trimethylolpropane. As crosslinkers, it is also possible to use diamines, sorbitol, glycerol, alkanolamines. If chain extenders and crosslinkers are used, their amount is preferably up to 5% by weight, based on the weight of the compounds having at least two active hydrogen atoms.

The process of the invention is usually carried out in the presence of activators, for example tertiary amines or organic metal compounds, in particular tin compounds. As tin compounds, preference is given to using divalent tin salts of fatty acids, e.g. tin dioctoate, and organotin compounds such as dibutyltin dilaurate.

As blowing agent c) for producing the polyurethane foams, preference is given to using water which reacts with the isocyanate groups to liberate carbon dioxide. Water is preferably used in an amount of from 0.5 to 6% by weight, particularly preferably in an amount of from 1.5 to 5.0% by weight, based on the weight of the component b). Together with or in place of water, it is also possible to use physically acting blowing agents, for example carbon dioxide, hydrocarbons such as n-pentane, isopentane or cyclopentane, cyclohexane or halogenated hydrocarbons such as tetrafluoroethane, pentafluoropropane, heptafluoropropane, pentafluorobutane, hexafluorobutane or dichloromonofluoroethane. The amount of the physical blowing agent is preferably in the range from 1 to 15% by weight, in particular from 1 to 10% by weight, and the amount of water is preferably in the range from 0.5 to 10% by weight, in particular from 1 to 5% by weight. Carbon dioxide is preferably used as physical blowing agent, particularly preferably in combination with water.

To produce the flexible polyurethane foams of the invention, stabilizers and also auxiliaries and/or additives can usually also be used.

Possible stabilizers are first and foremost polyether siloxanes, preferably water-soluble polyether siloxanes. These compounds generally have a structure in which a long-chain copolymer of ethylene oxide and propylene oxide is bound to a polydimethylsiloxane radical. Further foam stabilizers are described in U.S. Pat. Nos. 2,834,748, 2,917,480 and in U.S. Pat. No. 3,629,308.

The reaction is, if appropriate, carried out in the presence of auxiliaries and/or additives, e.g. fillers, cell regulators, surface-active compounds and/or flame retardants. Preferred flame retardants are liquid flame retardants on a halogen-phosphorus basis, e.g. trichloropropyl phosphate, trichloroethyl phosphate, and halogen-free flame retardants such as Exolit® OP 560 (Clariant International Ltd).

Further details of the starting materials, catalysts and also auxiliaries and additives used may be found, for example, in Kunststoff-Handbuch, Volume 7, Polyurethane, Carl-Hanser-Verlag Munich, 1st edition 1966, 2nd edition 1983 and 3rd edition 1993.

To produce polyurethanes of the invention, the organic polyisocyanates are reacted with the compounds having at least two active hydrogen atoms in the presence of the abovementioned blowing agents and also, if appropriate, the catalysts and auxiliaries and/or additives.

In the production of the polyurethanes of the invention, the isocyanate and the polyol component are usually combined in such amounts that the equivalence ratio of isocyanate groups to the sum of the active hydrogen atoms is from 0.7 to 1.25, preferably from 0.8 to 1.2.

The polyurethane foams are preferably produced by the one-shot process, for example with the aid of the high-pressure or low-pressure technique. The foams can be produced in open or closed metallic molds or by continuous application of the reaction mixture to conveyor belts to produce slabstock foams.

For the production of molded flexible foams, it is particularly advantageous to employ the two-component process in which a polyol component and an isocyanate component are produced and foamed. The components are preferably mixed at a temperature in the range from 15 to 90° C., preferably from 20 to 60° C. and particularly preferably from 20 to 35° C., and introduced into the mold or applied to the conveyor belt. The temperature in the mold is usually in the range from 20 to 110° C., preferably from 30 to 60° C. and particularly preferably from 35 to 55° C.

Flexible slabstock foams can be foamed in discontinuous or continuous plants, for example by the Planiblock process, the Maxfoam process, the Draka-Petzetakis process and the Vertifoam process.

The flexible polyurethane foams produced using polyether alcohols which are derived from renewable raw materials and have been prepared by means of DMC catalysis have, compared to products for which the polyether alcohols used according to the invention have been prepared from renewable raw materials by means of basic catalysts, a significantly reduced odor, significantly reduced fogging values and also significantly reduced crack formation and also an improved compression set before and after aging. Furthermore, the foams of the invention have a higher proportion of open cells, which shows up as, for example, an increased air permeability.

The compression set of the flexible polyurethane slabstock foams is not more than 10%, after aging in accordance with DIN EN ISO 2440, not more than 20%.

The air permeability of the viscoelastic flexible polyurethane foams of the invention is preferably at least 10 dm³/min, particularly preferably greater than 30 dm³/min and in particular greater than 50 dm³/min.

The viscoelastic flexible polyurethane foams of the invention have a very good aging resistance, in particular under hot and humid conditions. They are hydrophobic and swelling-resistant. The proportion of aromatic amines, in particular of 2,4- and 2,6-toluenediamine or MDA, in the foam is less than 1 ppm and does not increase even after prolonged use.

The flexible polyurethane foams of the invention are preferably used in motor vehicle interiors and in furniture and mattresses.

The invention is illustrated by the following examples.

Production of the Open-Celled Viscoelastic Flexible Polyurethane Foams

### EXAMPLES 1 TO 4

The starting materials listed in Table 1 were reacted in the ratios indicated in Table 1.

All components apart from the isocyanate were firstly combined by intensive mixing to give a polyol component. The isocyanate was then added while stirring and the reaction mixture was poured into an open mold in which it foamed to give the polyurethane foam. The properties of the foams obtained are shown in Table 1.

The following properties were determined according to the standards, operating methods and test methods stated:
Foam density in kg/m³ DIN EN ISO 845
VOC ricinoleic acid cycle in ppm PB VWL 709
FOG ricinoleic acid cycle in ppm PB VWL 709
Air permeability in dm³/min DIN EN ISO 7231
Compressive strength, 40% deformation, in kPa DIN EN ISO 2439
Indentation resistance, 25% deformation DIN EN ISO 2439
Indentation resistance, 40% deformation DIN EN ISO 2439
Indentation resistance, 65% deformation DIN EN ISO 2439
Elongation in % DIN EN ISO 1798
Tensile strength in kPa DIN EN ISO 1798
Rebound resilience in % DIN EN ISO 8307
Compression set in % DIN EN ISO 3386
Wet compression set Operating method AA U10-131-041 of Feb. 6, 2002

The wet compression set was determined in accordance with the operating method AA U10-131-041 of Feb. 6, 2002:

The height at a previously marked position on the foam test specimens having dimensions of 50 mm×50 mm×25 mm is determined by means of a sliding caliper or measuring caliper. The test specimens are subsequently placed between two pressure plates and compressed to the height by means of a clamping device using 7.5 mm spacers.

Storage at 50° C. and 95% relative atmospheric humidity in a temperature- and humidity-controlled chamber commences immediately after clamping. After 22 hours, the foam test specimens are quickly removed from the clamping device and temporarily stored for 30 minutes in a standard atmosphere on a surface having a low thermal conductivity (tray) to allow them to relax. The residual height at the marked position is subsequently determined using the same measuring instrument.

The wet compression set is based on the deformation and is calculated as follows:

Wet compression set=h₀−h_{R}*100/(h₀−7.5 mm) in %

h₀ original height in mm
h_{R} residual height of the test specimen in mm

TABLE 1

| | OHN | Ex. 1 | Ex. 2 | Ex. 3 | Ex. 4 |
|---|---|---|---|---|---|
| Lurpanol ® BALANCE 50 | 50 | 26 | 17 | 17 | 18 |
| Castor oil, grade DAB | 160.5 | 60 | 72 | 72 | 67 |
| Lutensol ® XA 40 | 150 | 7 | 14 | 14 | 11 |
| Lupranol ® 1000 | 55 | 7 | 7 | 7 | 4 |
| DABCO ® B198 | 0 | 0.60 | | | |
| Tegostab ® BF 2270 | 0 | | 0.60 | | 0.60 |
| Tegostab ® BF 2370 | | | | 1.0 | |
| Niax ® A1 | 560 | 0.26 | | 0.35 | 0.5 |
| Dabco ® 33LV | 425.8 | 0.17 | | 0.25 | 0.4 |
| Dabco ® NE 500 | 280 | | 0.44 | | |
| Dabco ® NE 600 | 270 | | 0.26 | | |
| Kosmos ® 29 | 0 | 0.26 | | 0.17 | |
| Kosmos ® EF | | | 0.26 | | |
| Kosmos ® 54 | 314 | 0.26 | 0.26 | | |
| Irgastab ® PUR 68 | 0 | 0.40 | 0.40 | 0.40 | 0.40 |
| Water (add.) | 6233 | 1.72 | 1.72 | 1.72 | 2.00 |

| | | | | |
|---|---|---|---|---|
| Lupranat ® T 80 A - Index | 105 | 105 | 105 | |
| Lupranat ® M20W and Lupranat ® MI - 3:1, Index | | | | 85 |
| Cream time in s | 12 | 12 | 8 | 8 |
| Full rise time in s | 180 | 180 | 120 | 170 |
| Foam density in kg/m³ | 47.4 | 47.9 | 51.8 | 52.3 |
| Compressive strength, 25% deformation, in kPa | 1.6 | 1.3 | 1.3 | 1.1 |
| Compressive strength, 40% deformation in kPa | 2.1 | 1.7 | 1.7 | 1.15 |
| Compressive strength, 65% deformation, in kPa | 4.8 | 4.1 | 4.3 | 2.1 |
| Tensile strength in kPa | 67 | 65 | 73 | 54 |
| Elongation in % | 154 | 151 | 154 | 70 |
| Compression set in % | 3.9 | 4.7 | 4.1 | 3.0 |
| Wet compression set | 13 | 14 | 12 | 12 |
| Rebound resilience in % | 14 | 8 | 8 | 7 |
| Air permeability in dm³/min | 40 | 70 | 50 | 50 |
| Biomass in % by weight in the foam | 48 | 47 | 47 | 48 |
| Storage under hot and humid conditions in | | | | |
| accordance with DIN EN ISO 2240, 1 cycle 5 h, | | | | |
| 120° C. | | | | |
| Compressive strength, 40% deformation, in kPa | 1.4 | 1.2 | | |
| Tensile strength in kPa | 56 | 60 | | |
| Elongation in % | 175 | 170 | | |
| Compression set in % | 8.0 | 9.1 | | |
| 2,4-TDA content in ppm | <1 | <1 | <1 | |
| 2,6-TDA content in ppm | <1 | <1 | <1 | |
| MDA content in ppm | | | | <1 |

Notes for the table
Lupranol ® BALANCE 50 polyetherol based on castor oil and having a hydroxyl number of 50 mg KOH/g and a viscosity of 725 mPa · s (BASF Aktiengesellschaft), prepared by means of DMC catalysis
Lupranol ® 1000 polypropylene glycol having a hydroxyl number of 55 mg KOH/g and a viscosity of 325 mPa · s (BASF Aktiengesellschaft)
Castor oil, grade DAB Alberdingk-Boley
Lutensol ® XA 40 C10-oxo alcohol ethoxylate +4 EO
Dabco ® 33 LV: 1,4-diazabicyclo[2.2.2]octane (33%) in dipropylene glycol (67%) (Air Products and Chemicals, Inc.)
Niax ® A1: bis(2-dimethylaminoethyl) ether (70%) in dipropylene glycol (30%), (Crompton Corporation)
Dabco ® NE 500 and 600 incorporable amine catalysts (Air Products and Chemicals, Inc.)
Kosmos ® 29: tin(II) salt of ethylhexanoic acid, (Degussa AG)
Kosmos ® EF and 54 incorporable tin or zinc catalysts (Degussa AG)
Tegostab ® BF 2270 and BF 2370 silicone stabilizers (Degussa AG)
DABCO ® 198 silicone stabilizer (Air Products and Chemicals, Inc.)
Irgastab ® PUR 68 amine-free antioxidant from CIBA AG
Lupranat ® T 80 A: tolylene 2,4-/2,6-diisocyanate mixture in a ratio of 80:20 (BASF Aktiengesellschaft)
Lupranat ® M20W mixture of diphenylmethane diisocyanate/polymethylenepolyphenylene polyisocyanates
Lupranat ® MI 1:1 mixture of diphenylmethane 2,4′-diisocyanate and diphenylmethane 4,4′-diisocyanate (BASF Aktiengesellschaft)
TDA toluenediamine
MDA methylenedi(phenylamine)

1. A process for producing open-celled viscoelastic flexible polyurethane foams by reacting:
a) a polyisocyanate
b) a polyol mixture comprising:
bi) a compound having at least two hydrogen atoms which are reactive toward isocyanate groups and an OH number that ranges from 20 to 100 mg KOH/g,
bii) a compound having at least two hydrogen atoms which are reactive toward isocyanate groups and an OH number that ranges from 100 to 800 mg KOH/g and
biii) a compound having at least one and not more than two hydrogen atoms which are reactive toward isocyanate groups and an OHN that ranges from 100 to 800 mg KOH/g,
c) and a blowing agent,
wherein bi) and bii) each comprise at least one compound which comprises a renewable raw material or a reaction product thereof.

2. The process according to claim 1, wherein the component b) comprises 5-45% by weight of bi), 30-90% by weight of bii) and 5-40% by weight of biii), in each case based on the sum of bi), bii) and biii).

3. The process according to claim 1, wherein reaction products of castor oil with alkylene oxides are used as component bi).

4. The process according to claim 1, wherein castor oil is used as component bii).

5. The process according to claim 1, wherein the component b) comprises 10-25% by weight of bi), 50-80% by weight of bii) and 10-30% by weight of biii), in each case based on the sum of bi), bii) and biii).

6. The process according to claim 1, wherein bi) and bii) are polyether alcohols prepared by addition of alkylene oxides onto compounds derived from renewable raw materials using DMC catalysts, said polyether alcohols having a content of cyclic fatty acid esters of not more than 10 ppm.

7. The process according to claim 1, wherein a monool, a diol, or a combination thereof having a hydroxyl number that ranges from 100 to 800 mg KOH/g is used as compound biii).

8. The process according to claim 1, wherein a mixture of 80% by weight of tolylene 2,4-diisocyanate and 20% by weight of tolylene 2,6-diisocyanate is used as the polyisocyanate.

9. The process according to claim 1, wherein water is used as the blowing agent.

10. The process according to claim 1, wherein the viscoelastic flexible polyurethane foam has an air permeability of at least 10 dm³/min.

11. The process according to claim 1, wherein the flexible polyurethane has a compression set of not more than 7%.

12. The process according to claim 1, wherein the flexible polyurethane foam has, after aging in accordance with DIN EN ISO 2440, of not more than 15%.

13. The process according to claim 1, wherein the renewable raw material is present in a proportion of at least 20% by weight, based on the polyurethane foam.

14. An open-celled viscoelastic flexible polyurethane slabstock foam produced by the process according to claim 1.

15-16. (canceled)

17. A furniture, mattress, or cushion comprising the flexible polyurethane foam produced by the process according to claim 12.

18. A motor vehicle interior comprising the flexible polyurethane foam produced by the process according to claim 12.
